(19) United States
(12) Patent Application Publication
(10) Pub. No.: US 2006/0071482 A1
(43) Pub. Date: Apr. 6, 2006

(54) Apparatus for opening a closed latch and method for using the same

(76) Inventor: Gordon Tang, Bellevue, WA (US)

Correspondence Address: Robert M. Storwick, PO Box 386, Mercer Island, WA, 98040, US

(21) Appl. No.: 10/951,959

(22) Filed: Sep. 28, 2004

(51) Int. Cl. E05C 19/18

(52) U.S. Cl. 292/288

(57) ABSTRACT

An apparatus for opening a closed latch and method for using the same. An elongated resilient member is fashioned and pushed between a latched door and its door frame through a hole in a doorstop toward the mechanism of the closed latch. After the member has been pushed past the mechanism of the closed latch, it can be turned about its longitudinal axis to move the latch to an open position, allowing the latched door to be opened.

### TECHNICAL FIELD

The present invention relates to apparatus and methods for operating latches, and more particularly, to apparatus and methods for opening a closed latch.

### BACKGROUND OF THE INVENTION

Latches for securing doors to door frames have been known for millennia. Such latches are generally used to prevent access to a first area through a door from a second area. While such latches are generally useful for securing an area, from time to time, emergencies arise that demand that the security can be breached to save lives and/or property. Examples include situations where a person inside a secured area has become incapacitated or is otherwise incapable of acting to protect themselves, requiring the use of assistance from outside the secured area.

While such situations can often be handled by brute force methods such as breaking down a door, it can be more expeditious to have an apparatus and/or method for breaching the door without causing irreparable damage to the door or its frame or associated hardware. This is especially the case where a door is primarily secured by a key-operated mechanism and secondarily secured by an unkeyed mechanism.

Many such unkeyed mechanisms feature a latch that falls or is maneuvered into a locked or closed position, and to open such a latch requires that the latch be maneuvered out of the locked or closed position. Unfortunately, in many cases, such maneuvering is not available and unnecessary losses occur because there is not enough time available to quickly and efficiently overcome such latches.

It is therefore desirable to provide apparatus and methods for opening a closed latch.

### SUMMARY OF THE INVENTION

According to a first aspect, the invention is an apparatus for opening a closed latch that can be moved to a closed position by a directional closing movement of a mechanism and opened in a directional opening movement that is opposite in direction to the directional closing movement. The mechanism is accessible through a longitudinal hole that is unaligned with the mechanism. The direction of the opening movement of the mechanism is substantially perpendicular to the longitudinal hole.

The apparatus includes a substantially elongated resilient member having a first end portion that is connected by means of a first curved portion to a second portion. The second portion is connected by means of a third portion to a second end portion. The first curved portion has greater curvature along its length than either of the first end portion or the second portion have along their lengths. The combined length of the first end portion, the first curved portion and the second portion is greater than the distance through the longitudinal hole to the mechanism. The second portion has a curvature that is sufficiently small so that the second portion defines a longitudinal axis. The second end portion has a length and is angularly disposed relative to the second portion sufficiently so that the resilient member can be turned relative to the longitudinal axis without undue effort.

The first curved portion of the resilient member flexes so that the resilient member can be passed through the longitudinal hole. This allows the first end portion, the first curved portion and at least part of the second portion to be passed through the longitudinal hole so that the resilient member is adjacent the mechanism. The resilient member can be turned through an angle relative to its longitudinal axis until the a first end portion is oriented to engage the mechanism. This is followed by a step where the resilient member can be partially withdrawn from the longitudinal hole until the first end portion engages the mechanism and causes the mechanism to be moved sufficiently in the direction of the opening movement so that the latch is opened.

According to a second aspect, the invention is an apparatus for opening a closed latch that can be closed by a directional closing movement of a mechanism to deny access to a first space from a second space and opened in a directional opening movement that is opposite in direction to the directional closing movement. The mechanism is accessible from the second space through a longitudinal hole that is not aligned with the mechanism. The direction of the opening movement of the mechanism is substantially perpendicular to the longitudinal hole.

The apparatus includes a substantially elongated resilient member having a first end portion that is connected by means of a first convexly curved portion to a second portion. The second portion is connected by means of a third convexly curved portion to a second end portion. The first convexly curved portion has greater curvature than the second portion. The combined length of the first end portion and the first and second portions is greater than the distance from the second space through the longitudinal hole to the mechanism. The second portion has a curvature that is sufficiently small so that the second portion defines a longitudinal axis. The second end portion has a length and is angularly disposed relative to the second portion sufficiently so that the resilient member can be turned relative to the longitudinal axis without undue effort.

Accordingly, the resilient member can be passed from the second space through the longitudinal hole so that the first end portion, the first convexly curved portion and at least part of the second portion can be passed through the longitudinal hole so that the resilient member is adjacent the mechanism. This allows the resilient member to be turned through an obtuse angle relative to its longitudinal axis until the first end portion is oriented to engage the mechanism. Following this, the resilient member can be partially withdrawn from the first space through the longitudinal hole until the first end portion engages the mechanism and causes the mechanism to be moved sufficiently in the direction of the opening movement so that the latch is opened.

According to a third aspect, the invention is an apparatus for opening a closed latch that can be closed by a downward movement of a mechanism, where the latch is attached to a door frame. The door frame has a doorstop that denies access to a first space through the door from a second space when the latch is closed. The latch is opened in a directional opening movement that is opposite in direction to the directional closing movement. The doorstop has a substantially horizontal hole therethrough below the mechanism.

The apparatus includes a substantially elongated resilient member having a first convexly curved end portion that is longer than the horizontal hole through the doorstop. The first convexly curved end portion is connected by means of a first convexly curved connection portion to a second convexly curved connection portion. The second portion is connected by means of a third convexly curved connection portion to a second end portion. The first convexly curved connection portion has a greater curvature than the second convexly curved portion. The combined length of the first end portion and the first and second curved connection portions is greater than the width of the door frame. The second curved portion has a curvature that is sufficiently small so that the second curved portion defines a longitudinal axis. The second end portion has a length and is angularly disposed relative to the second curved connection portion sufficiently so that the resilient member can be turned relative to the longitudinal axis without undue effort.

Accordingly, the resilient member can be passed through the horizontal hole so that the first curved end portion, the first curved connection portion and at least part of the second curved connection portion can be passed through the horizontal hole so that the resilient member is below the mechanism. This allows the resilient member to be turned through an angle of substantially 180 degrees relative to its longitudinal axis until the first end portion bears against the mechanism. After this, the resilient member can be partially withdrawn from the horizontal hole until the first curved end portion causes the mechanism to be lifted upwardly sufficiently so that it is opened.

According to a fourth aspect, the invention is an apparatus for opening a closed latch that can be closed by a downward movement of a mechanism. The latch is attached to a door frame having a doorstop and denies access to a first space through a door from a second space when the latch is closed. The door is capable of closing against the doorstop and the latch has a strikeplate that receives a bolt from the door. The latch is opened in a directional opening movement that is opposite in direction to the directional closing movement. The doorstop has a substantially horizontal hole therethrough below the mechanism.

The apparatus includes a substantially elongated resilient member having a first end portion that is longer than the horizontal hole through the doorstop. The first end portion is connected by means of a first convexly curved connection portion to a second convexly curved connection portion. The second portion is connected by means of a third convexly curved connection portion to a second end portion. The first convexly curved connection portion has a greater curvature than the second convexly curved connection portion.

The combined length of the first end portion and the first and second convexly curved connection portions is greater than the width of the door frame. The third convexly curved connection portion has greater curvature than the second convexly curved connection portion, and the second end portion is at a substantially right angle to the second convexly curved connection portion.

Accordingly, the resilient member can be passed through the horizontal hole from the second space so that the first end portion, the first convexly curved connection portion and at least part of the second convexly curved connection portion can be passed through the horizontal hole from the second space toward the first space in such a way that the resilient member is above the bolt and below the mechanism. This allows the resilient member to be turned through an angle of substantially 180 degrees relative to its longitudinal axis until the first end portion bears against the mechanism. After this, the resilient member can be partially withdrawn from the horizontal hole toward the second space until the first convexly curved end portion causes the mechanism to be lifted upwardly sufficiently so that it is opened.

According to a fifth aspect, the invention is a method for opening a closed latch that can be moved to a closed position by a directional closing movement of a mechanism and opened in a directional opening movement that is opposite in direction to the directional closing movement. The mechanism is accessible through a longitudinal hole that is not aligned with the mechanism. The direction of the opening movement of the mechanism is substantially perpendicular to the longitudinal hole.

The method includes the step of: a) forming a substantially elongated resilient member having a first end portion that is connected by means of a first curved portion to a second portion. The second portion is connected by means of a third portion to a second end portion. The first curved portion has greater curvature along its length than either of the first end portion or the second portion have along their lengths. The combined length of the first end portion, the first curved portion and the second portion is greater than the distance through the longitudinal hole to the mechanism.

The second portion has a curvature that is sufficiently small so that the second portion defines a longitudinal axis. The second end portion has a length and is angularly disposed relative to the second portion sufficiently so that the resilient member can be turned relative to the longitudinal axis without undue effort.

The method also includes the steps of b) passing the first end portion, the first curved portion and at least part of the second portion through the longitudinal hole so that the resilient member is adjacent the mechanism, and c) turning the resilient member through an angle relative to its longitudinal axis until the first end portion is oriented to engage the mechanism.

The method further includes the steps of d) partially withdrawing the resilient member from the longitudinal hole until the first end portion engages the mechanism, and e) causing the mechanism to be moved sufficiently in the direction of the opening movement so that the latch is opened.

According to a sixth aspect, the invention is a method for opening a closed latch that can be closed by a directional closing movement of a mechanism to deny access to a first space from a second space. The closed latch can also be opened in a directional opening movement that is opposite in direction to the directional closing movement.

The mechanism is accessible from the second space through a longitudinal hole that is not aligned with the mechanism. The direction of the opening movement of the mechanism is substantially perpendicular to the longitudinal hole.

The method includes the steps of a) forming the longitudinal hole, and b) forming a substantially elongated resilient member having a first end portion that is connected by means of a first convexly curved portion to a second portion. The second portion is connected by means of a third convexly curved portion to a second end portion. The first convexly curved portion has greater curvature than the second portion. The combined length of the first end portion and the first and second portions is greater than the distance from the second space through the longitudinal hole to the mechanism. The second portion has a curvature that is sufficiently small so that the second portion defines a longitudinal axis.

The second end portion has a length and is angularly disposed relative to the second portion sufficiently so that the resilient member can be turned relative to the longitudinal axis without undue effort.

The method also includes the step of c) passing the resilient member from the second space through the longitudinal hole so that the first end portion, the first convexly curved portion and at least part of the second portion are passed through the longitudinal hole so that the resilient member is adjacent the mechanism.

The method further includes the steps of d) turning the resilient member through an obtuse angle relative to its longitudinal axis until the first end portion is oriented to engage the mechanism, and e) partially withdrawing the resilient member from the first space through the longitudinal hole until the first end portion engages the mechanism.

The method also includes the step of f) causing the mechanism to be moved sufficiently in the direction of the opening movement so that the latch is opened.

According to a seventh aspect, the invention is a method for opening a closed latch that can be closed by a downward movement of a mechanism, where the latch is attached to a door frame having a doorstop. The latch denies access to a first space through the door from a second space when the latch is closed.

The latch further is opened in a directional opening movement that is opposite in direction to the directional closing movement. The doorstop has a substantially horizontal hole therethrough below the mechanism.

The method includes the step of a) forming a substantially elongated resilient member having a first convexly curved end portion that is longer than the horizontal hole through the doorstop. The first convexly curved end portion is connected by means of a first convexly curved connection portion to a second convexly curved connection portion. The second connection portion is connected by means of a third convexly curved connection portion to a second end portion. The first convexly curved connection portion has a greater curvature than the second convexly curved portion. The combined length of the first end portion and the first and second curved connection portions is greater than the width of the door frame. The second curved portion has a curvature that is sufficiently small so that the second curved portion defines a longitudinal axis. The second end portion has a length and is angularly disposed relative to the second curved connection portion sufficiently so that the resilient member can be turned relative to the longitudinal axis without undue effort.

The method also includes the steps of b) passing the first curved end portion, the first curved connection portion and at least part of the second curved connection portion through the horizontal hole so that the resilient member is below the mechanism, and c) turning the resilient member through an angle of substantially 180 degrees relative to its longitudinal axis until the first end portion bears against the mechanism.

The method further includes the step of d) partially withdrawing the resilient member from the horizontal hole until the first curved end portion causes the mechanism to be lifted upwardly sufficiently so that it is opened.

According to a eighth aspect, the invention is a method for opening a closed latch that can be closed by a downward movement of a mechanism, where the latch is attached to a door frame having a doorstop. The latch also denies access to a first space through a door from a second space when the latch is closed.

The door is capable of closing against the doorstop and the latch has a strikeplate that receives a bolt from the door. The latch further can be opened in a directional opening movement that is opposite in direction to the directional closing movement. The doorstop has a substantially horizontal hole therethrough below the mechanism.

The method includes the step of a) forming a substantially elongated resilient member having a first end portion that is longer than the horizontal hole through the doorstop. The first end portion is connected by means of a first convexly curved connection portion to a second convexly curved connection portion. In turn the second connection portion is connected by means of a third convexly curved connection portion to a second end portion. The first convexly curved connection portion has a greater curvature than the second convexly curved connection portion. The combined length of the first end portion and the first and second convexly curved connection portions is greater than the width of the door frame. The third convexly curved connection portion has greater curvature than the second convexly curved connection portion and the second end portion is at a substantially right angle to the second convexly curved connection portion.

The method also includes the step of b) passing the resilient member through the horizontal hole from the second space so that the first end portion, the first convexly curved connection portion and at least part of the second convexly curved connection portion can be passed through the horizontal hole from the second space toward the first space so that the resilient member is above the bolt and below the mechanism.

The method further includes the steps of c) turning the resilient member through an angle of substantially 180 degrees relative to its longitudinal axis until the first end portion bears against the mechanism; and d) partially withdrawing the resilient member from the horizontal hole toward the second space until the first convexly curved end portion causes the mechanism to be lifted upwardly sufficiently so that it is opened.

### BRIEF DESCRIPTION OF THE DRAWINGS

FIG. 1 is a perspective view of a preferred embodiment of the invention.

FIG. 2 is an elevation view of a preferred embodiment of the invention, showing a first stage of a use of the invention.

FIG. 3 is an elevation view of a preferred embodiment of the invention, showing a second stage of a use of the invention.

FIG. 4 is an elevation view of a preferred embodiment of the invention, showing a third stage of a use of the invention.

FIG. 5 is an elevation view of a preferred embodiment of the invention, showing a fourth stage of a use of the invention.

FIG. 6 is an elevation view of a preferred embodiment of the invention, showing a fifth stage of a use of the invention.

FIG. 7 is an elevation view of a preferred embodiment of the invention, showing a sixth stage of a use of the invention.

FIG. 8 is an elevation view of a preferred embodiment of the invention, showing a seventh stage of a use of the invention.

FIG. 9 is an elevation view of a preferred embodiment of the invention, showing a eighth stage of a use of the invention.

### DETAILED DESCRIPTION OF THE PREFERRED EMBODIMENT OF THE INVENTION

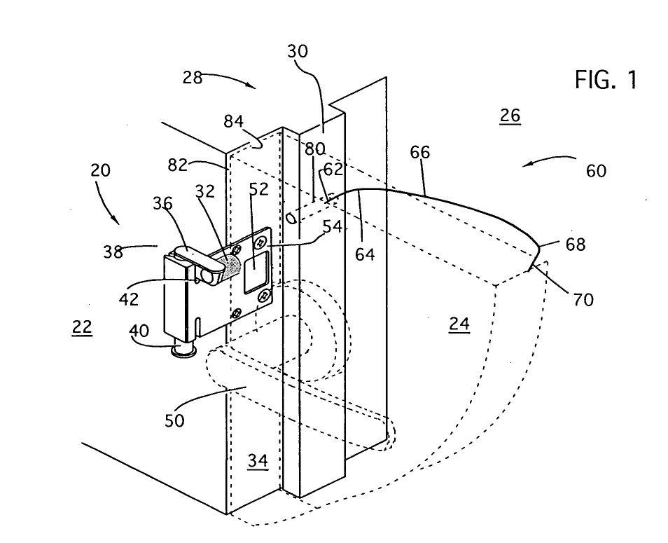

FIG. 1 is a perspective view of a preferred embodiment of the invention. A latch 20 secures a first area 22 (an inside area) on one side of a door 24 (shown in dashed lines) from a second area 26 (an outside area) on the other side of the door 24. The latch 20 is attached to a door frame 28 that includes a doorstop 30. The door frame 28 can be made from such materials as wood and metal and the doorstop 30 can be integral to the door frame 28 or fit as a separate pieces of material.

The latch 20 includes a relatively soft stop 32 that impinges on the inside surface 34 of the door 24 when the latch 20 is closed without marring the inside surface 34. The stop 32 is attached to an arm 36 which is placed at an upper end 38 of a cylinder 40. When the latch 20 is activated, the cylinder 40 is turned toward the door 24 until the arm 36 falls downward into a slot 42, securing the first area 22 from the second area 26.

The latch 20 is preferably made from a very strong metal to resist tampering and can be provided with a wide variety of desirable finishes. A non-magnetic metal such as stainless steel resists unauthorized attempts to breach the lock by using magnets.

The operation of a latch can characterized as being movable to a closed position by a directional closing movement and being movable to a open position by a directional opening movement. In the case of the latch 20, the directional closing movement is the downward motion of the cylinder 40 when the arm 36 becomes aligned with the slot 42 and the directional opening movement is the upward motion of the cylinder 40 when the arm 36 is pushed up above of the slot 42 so that the arm 36 can rotate with the cylinder 40.

The door 24 also typically includes a door closure such as a door handle 50 (shown in dashed lines) that operates to close the door and also generally operates a conventional bolt (not shown) that projects into an aperture 52 in a strikeplate 54 when the door 24 is closed.

One preferred embodiment of the inventive apparatus is the elongated resilient member 60. The member 60 can be made from a resilient wire (for example, made from bedspring wire) with a relatively small diameter (for example, 0.050 inch), allowing it to be bent to a desired shape but having sufficient resilience to be bent slightly without losing its formed shape. While it is preferably prepared beforehand, the member 60 can easily be fashioned by hand on the spot. Other suitable materials will be known to those skilled in the relevant arts.

The member 60 has a first end portion 62, a first connection portion 64, a second connection portion 66, a third connection portion 68, and a second end portion 70. The first end portion 62 is used to manipulate the mechanism of the latch 20 and the first connection portion 64 provides a transition from the first end portion 62 to the second connection portion 66. The combined length of the first end portion 62, the first connection portion 64 and the second connection portion 66 exceeds the width of the door frame 28 so that the member 60 can be used to manipulate the mechanism of the latch 20 from outside the door 24 and door frame 28.

In a preferred embodiment, the first end portion 62 of the member 60 is bent slightly downward, giving it a convex shape with a modest curvature. The first connection portion 64 also has a convex shape, but with a greater curvature than the first end portion 62.

The second connection portion 66 is the longest portion of the member 60. It also has a convex shape, but with a less curvature than either the first end portion 62 or the first connection portion 64. The curvature of the second connection portion 66 is so slight that it serves to define an overall longitudinal axis of the member 60.

The third connection portion 68 also has a convex shape, with a very sharp curvature between the second connection portion 66 and the second end portion 70. The second end portion 70 can be generally straight, and serves as a handle to turn the member 60 on its longitudinal axis after it has been inserted properly toward the latch 20. It has been found that approximately 1½ inch is a suitable length for the second end portion 70. The angular position of the second end portion 70 is indicative of the angular position of the first end portion 62. However, preferably, the member 60 is formed to be planar, so that the angular position of the second end portion 70 is readily indicative of the angular position of the first end portion 62.

In preparation for using the member 60, a horizontal hole 80 (typically ⅛ to 3/16 inch in diameter) is drilled through the doorstop 30 from the second area 26 toward the first area 22. The hole 80 is placed close to the door frame 28 so that the member 60 can be slipped through the gap 82 between the door ram 28 and the end 84 of the door 24. A conventional 6 to 8 inch drill bit is suitable to drill the desired hole 80. Holes in other directions can be drilled as appropriate for the latch and door combination that must be opened in any given circumstance. Generally, the hole 80 is drilled so that it is not aligned with the mechanism of the latch in order to allow the member 60 to maneuver the mechanism of the latch.

In practice, if an attempt is made by an unauthorized person to drill such a hole, the noise of the attempt will be sufficient to alarm those inside the first area, allowing them to take protective measures.

As shown in the following figures, the member 60 can be manipulated to open the latch 20 from its closed position. Where the same features are shown in the following figures, they are given the same reference numerals.

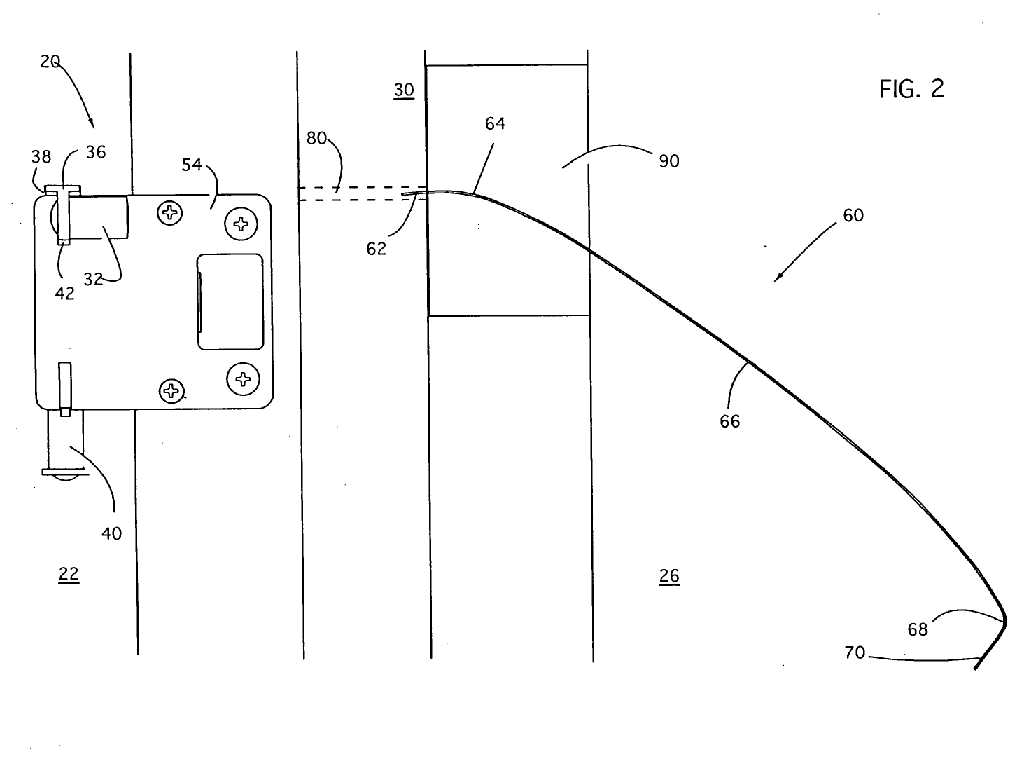

FIG. 2 is an elevation view of a preferred embodiment of the invention, showing a first stage of a use of the invention. Here the hole 80 has been drilled in the doorstop 30 and the first end portion 62 of the member 60 has been inserted into the hole 80 from the outside of the door frame 28. The shields 90 are made from a thin metal and temporarily attached to the door frame 28 and/or the door 24 to prevent marring them while the hole 80 is being drilled. The resiliency of the material from which the member 60 is made allows the first connection portion 64 to bend as the first end portion 62 of the member 60 is forced through the hole 80.

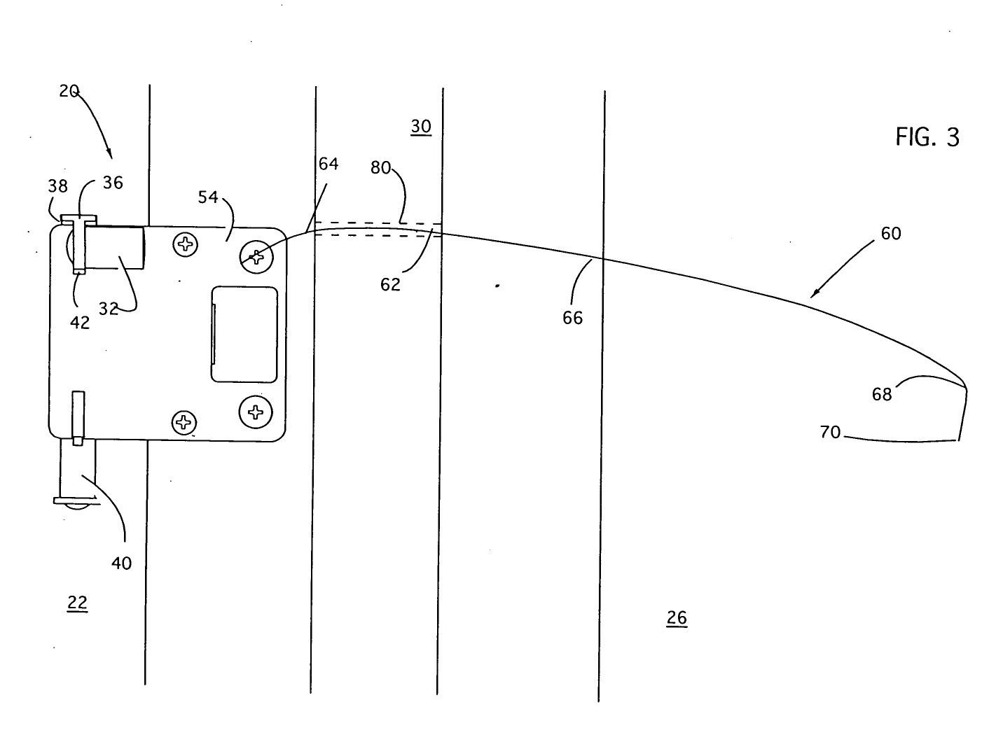

FIG. 3 is an elevation view of a preferred embodiment of the invention, showing a second stage of a use of the invention. In this second stage, the first end portion 62 and the first connection portion 64 of the member 60 have passed through the hole 80. In this embodiment, the first connection portion 64 is more curved than the first end portion 62, so the first end portion 62 is pointed downward where it can pass above the bolt in the aperture 52 and below the arm 36 of the latch 20.

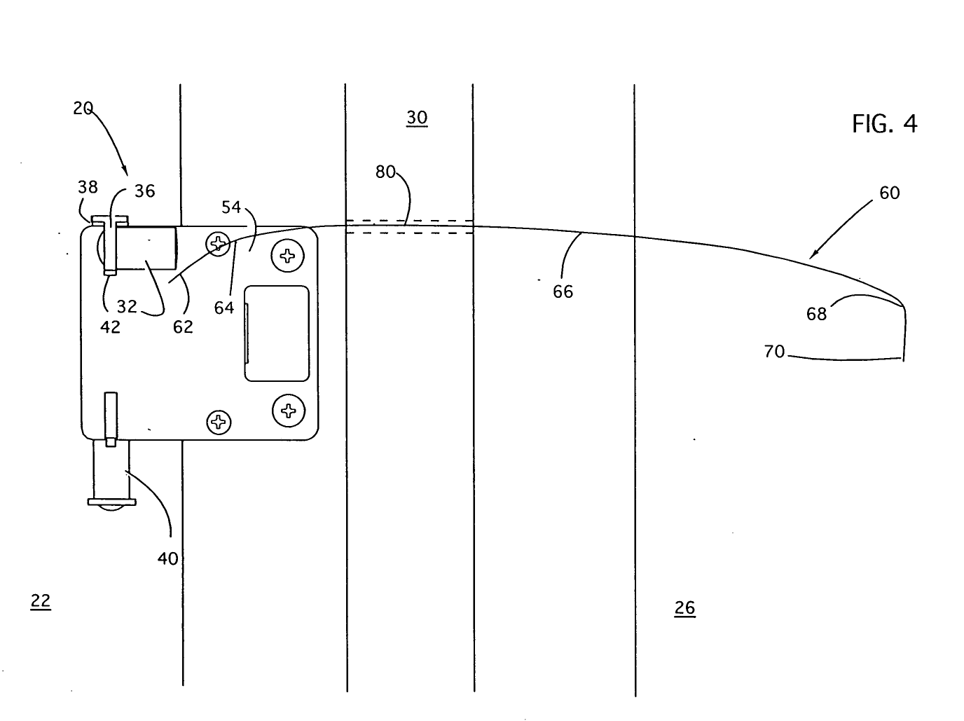

FIG. 4 is an elevation view of a preferred embodiment of the invention, showing a third stage of a use of the invention. In this third stage, the first end portion 62 and the first connection portion 64 of the member 60 are well past the hole 80 and over the bolt in the aperture 52 and are approaching the mechanism of the latch 20.

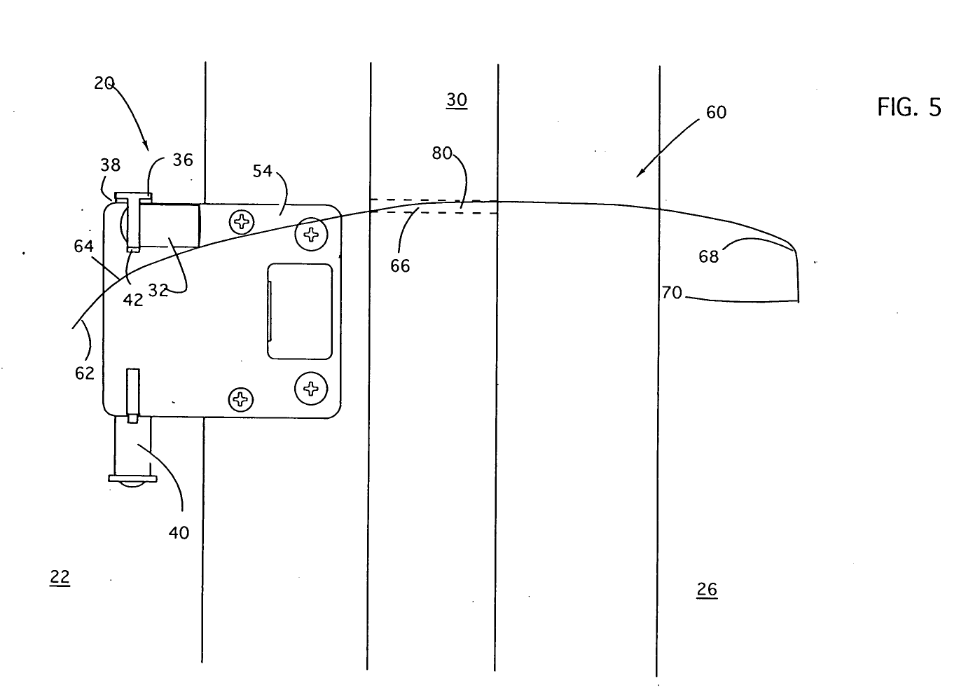

FIG. 5 is an elevation view of a preferred embodiment of the invention, showing a fourth stage of a use of the invention. In this fourth stage, the member 60 is inserted approximately half-way through the hole 80, so that the first end 62 of the member 60 is past the mechanism of the latch 20.

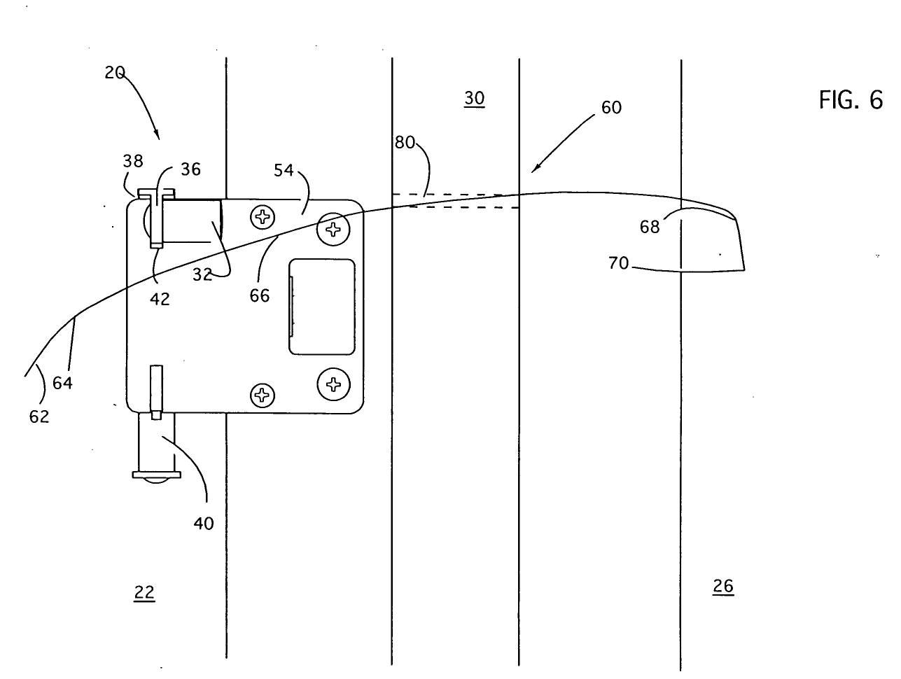

FIG. 6 is an elevation view of a preferred embodiment of the invention, showing a fifth stage of a use of the invention. In this fifth stage, the member 60 is inserted so that the second end portion 70 of the member 60 is approaching the door frame 28. This assures that the first end portion 62 of the member 60 is well past the mechanism of the latch 20.

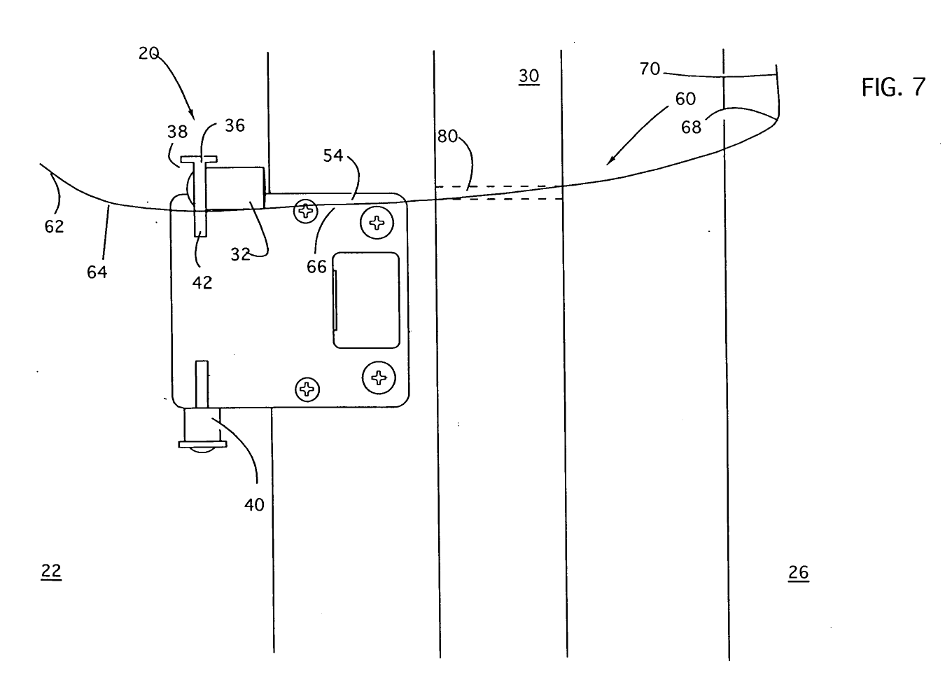

FIG. 7 is an elevation view of a preferred embodiment of the invention, showing a sixth stage of a use of the invention. In this sixth stage, the member 60 has been rotated approximately 180 degrees about its longitudinal axis using the second end portion 70 as a handle. The resiliency of the member 60 has allowed the member 60 to contact and lift the lower portion of the arm 36, raising the cylinder 40 and the stop 32 approximately half-way out of the slot 42.

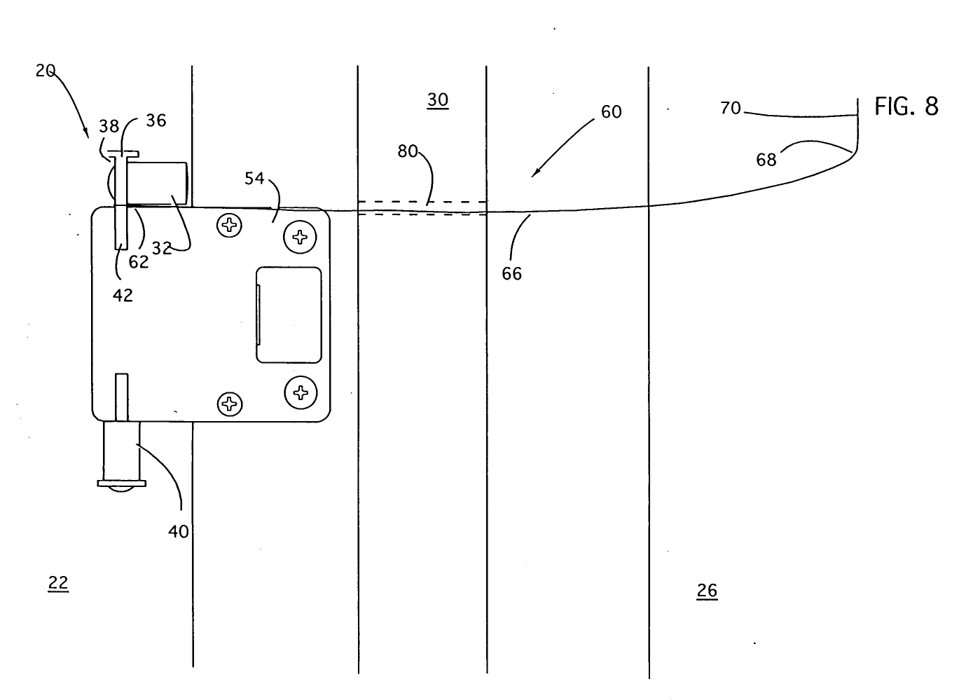

FIG. 8 is an elevation view of a preferred embodiment of the invention, showing a seventh stage of a use of the invention. In this seventh stage, the member 60 is being withdrawn from the hole 80 and has reached the point where the end of the first end portion 62 of the member 60 is supporting the lower portion of the arm 36 above the slot 42. By the time that the member 60 has reached this position, it is possible to push on the door (see FIG. 1) which, in turn, will push against the stop 32 and force the cylinder 40 of the latch 32 to rotate out of the way of the door 24. This will allow the door 24 to be opened.

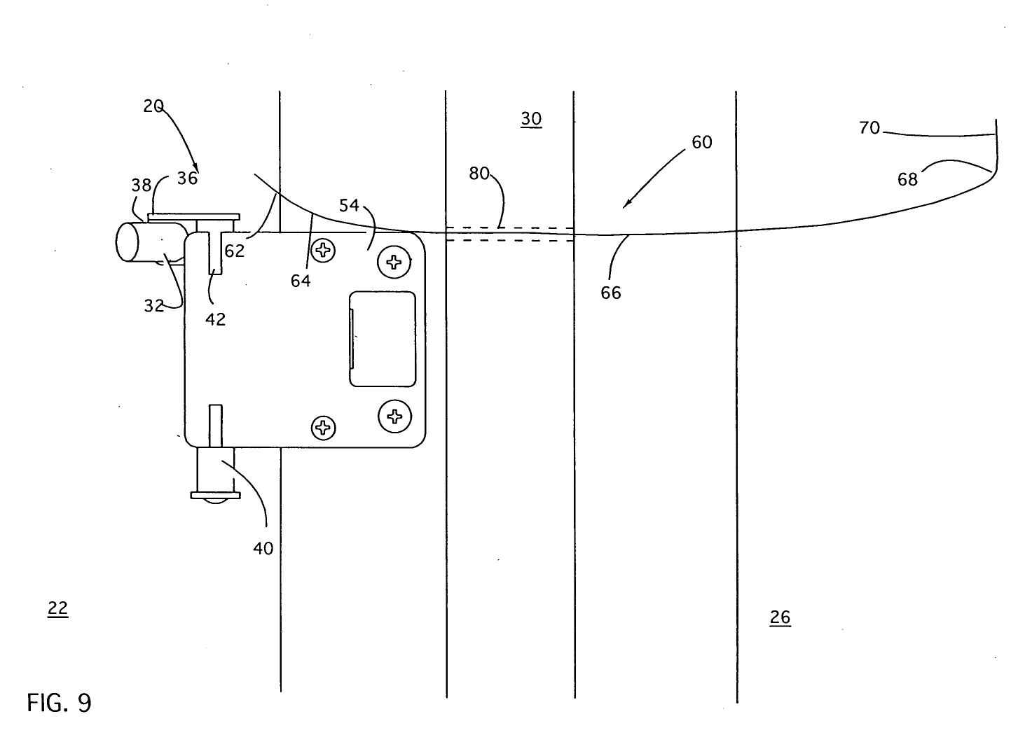

FIG. 9 is an elevation view of a preferred embodiment of the invention, showing a eighth stage of a use of the invention. In this stage, the first end portion 62 of the member 60 has been pulled past the arm 36. It has been found in practice that if no attempt to push the door 24 open was made in the seventh stage of this use of the invention, the resiliency of the member 60 will impart sufficient energy to the mechanism of the latch 20 to cause the mechanism to move from the closed position to a stable open position. After the latch 20 has been opened by means of the member 60, the hole 80 can be patched and painted over, hiding the hole 80 from view.

While the foregoing is a detailed description of the preferred embodiment of the invention, there are many alternative embodiments of the invention that would occur to those skilled in the art and which are within the scope of the present invention. Accordingly, the present invention is to be determined by the following claims.

1. An apparatus for opening a closed latch that can be moved to a closed position by a directional closing movement of a mechanism and opened in a directional opening movement that is opposite in direction to the directional closing movement, the mechanism being accessible through a longitudinal hole that is unaligned with the mechanism, the direction of the opening movement of the mechanism being substantially perpendicular to the longitudinal hole, the apparatus comprising:
a substantially elongated resilient member having a first end portion that is connected by means of a first curved portion to a second portion which is connected by means of a third portion to a second end portion, the first curved portion having greater curvature along its length than either of the first end portion or the second portion have along their lengths, the combined length of the first end portion, the first curved portion and the second portion being greater than the distance through the longitudinal hole to the mechanism, the second portion having a curvature that is sufficiently small so that the second portion defines a longitudinal axis, the second end portion having a length and being angularly disposed relative to the second portion sufficiently so that the resilient member can be turned relative to the longitudinal axis without undue effort,
whereby the first curved portion of the resilient member flexes so that the resilient member can be passed through the longitudinal hole, allowing the first end portion, the first curved portion and at least part of the second portion to be passed through the longitudinal hole so that the resilient member is adjacent the mechanism, whereupon the resilient member can be turned through an angle relative to its longitudinal axis until the first end portion is oriented to engage the mechanism, following which the resilient member can be partially withdrawn from the longitudinal hole until the first end portion engages the mechanism and causes the mechanism to be moved sufficiently in the direction of the opening movement so that the latch is opened.

2. The apparatus of claim 1, wherein the resilient member imparts sufficient energy to the mechanism as the first end portion of the resilient member is withdrawn past the mechanism so that the mechanism is caused to move from the closed position to a stable open position.

3. The apparatus of claim 1, wherein the second end portion of the resilient member indicates the angle through which the resilient member has been turned relative to its longitudinal axis.

4. The apparatus of claim 1, wherein at least one of the second or third portions of the resilient member is convexly curved.

5. The apparatus of claim 1, wherein the resilient member is planar.

6. An apparatus for opening a closed latch that can be closed by a directional closing movement of a mechanism to deny access to a first space from a second space and opened in a directional opening movement that is opposite in direction to the directional closing movement, the mechanism being accessible from the second space through a longitudinal hole that is unaligned with the mechanism, the direction of the opening movement of the mechanism being substantially perpendicular to the longitudinal hole, the apparatus comprising:
a substantially elongated resilient member having a first end portion that is connected by means of a first convexly curved portion to a second portion which is connected by means of a third convexly curved portion to a second end portion, the first convexly curved portion having greater curvature than the second portion, the combined length of the first end portion and the first and second portions being greater than the distance from the second space through the longitudinal hole to the mechanism, the second portion having a curvature that is sufficiently small so that the second portion defines a longitudinal axis, the second end portion having a length and being angularly disposed relative to the second portion sufficiently so that the resilient member can be turned relative to the longitudinal axis without undue effort,
whereby the resilient member can be passed from the second space through the longitudinal hole so that the first end portion, the first convexly curved portion and at least part of the second portion can be passed through the longitudinal hole so that the resilient member is adjacent the mechanism, whereupon the resilient member can be turned through an obtuse angle relative to its longitudinal axis until the first end portion is oriented to engage the mechanism, following which the resilient member can be partially withdrawn from the first space through the longitudinal hole until the first end portion engages the mechanism and causes the mechanism to be moved sufficiently in the direction of the opening movement so that the latch is opened.

7. The apparatus of claim 6, wherein the resilient member imparts sufficient energy to the mechanism as the first end portion of the resilient member is withdrawn past the mechanism so that the mechanism is caused to move from the closed position to a stable open position.

8. The apparatus of claim 6, wherein the second end portion of the resilient member indicates the angle through which the resilient member has been turned relative to its longitudinal axis.

9. The apparatus of claim 6, wherein the second portion and the second end portion of the resilient member are convexly curved.

10. An apparatus for opening a closed latch that can be closed by a downward movement of a mechanism, the latch being attached to a door frame having a doorstop and denying access to a first space through the door from a second space when the latch is closed, the latch further being opened in a directional opening movement that is opposite in direction to the directional closing movement, the doorstop having a substantially horizontal hole therethrough below the mechanism, the apparatus comprising:
a substantially elongated resilient member having a first convexly curved end portion that is longer than the horizontal hole through the doorstop, the first convexly curved end portion being connected by means of a first convexly curved connection portion to a second convexly curved connection portion that is connected by means of a third convexly curved connection portion to a second end portions the first convexly curved connection portion having a greater curvature than the second convexly curved portion, the combined length of the first end portion and the first and second curved connection portions being greater than the width of the door frame, the second curved portion having a curvature that is sufficiently small so that the second curved portion defines a longitudinal axis, the second end portion having a length and being angularly disposed relative to the second curved connection portion sufficiently so that the resilient member can be turned relative to the longitudinal axis without undue effort,
whereby the resilient member can be passed through the horizontal hole so that the first curved end portion, the first curved connection portion and at least part of the second curved connection portion can be passed through the horizontal hole so that the resilient member is below the mechanism, whereupon the resilient member can be turned through an angle of substantially 180 degrees relative to its longitudinal axis until the first end portion bears against the mechanism, following which the resilient member can be partially withdrawn from the horizontal hole until the first curved end portion causes the mechanism to be lifted upwardly sufficiently so that it is opened.

11. The apparatus of claim 10, wherein the resilient member imparts sufficient energy to the mechanism as the first end portion of the resilient member is withdrawn past the mechanism so that the mechanism is caused to move from the closed position to a stable open position.

12. The apparatus of claim 10, wherein the resilient member follows a planar convex curve.

13. An apparatus for opening a closed latch that can be closed by a downward movement of a mechanism, the latch being attached to a door frame having a doorstop and denying access to a first space through a door from a second space when the latch is closed, the door being capable of closing against the doorstop and the latch having a strikeplate that receives a bolt from the door, the latch further being opened in a directional opening movement that is opposite in direction to the directional closing movement, the doorstop having a substantially horizontal hole therethrough below the mechanism, the apparatus comprising:
a substantially elongated resilient member having a first end portion that is longer than the horizontal hole through the doorstop, the first end portion being connected by means of a first convexly curved connection portion to a second convexly curved connection portion that is connected by means of a third convexly curved connection portion to a second end portion, the first convexly curved connection portion having a greater curvature than the second convexly curved connection portion, the combined length of the first end portion and the first and second convexly curved connection portions being greater than the width of the door frame, the third convexly curved connection portion having greater curvature than the second convexly curved connection portion and the second end portion being at a substantially right angle to the second convexly curved connection portion,
whereby the resilient member can be passed through the horizontal hole from the second space so that the first end portion, the first convexly curved connection portion and at least part of the second convexly curved connection portion can be passed through the horizontal hole from the second space toward the first space so that the resilient member is above the bolt and below the mechanism, whereupon the resilient member can be turned through an angle of substantially 180 degrees relative to its longitudinal axis until the first end portion bears against the mechanism, following which the resilient member can be partially withdrawn from the horizontal hole toward the second space until the first convexly curved end portion causes the mechanism to be lifted upwardly sufficiently so that it is opened.

14. The apparatus of claim 13, wherein the resilient member imparts sufficient energy to the mechanism as the first end portion of the resilient member is withdrawn past the mechanism so that the mechanism is caused to move from the closed position to a stable open position.

15. The apparatus of claim 13, wherein the resilient member follows a planar convex curve.

16. A method for opening a closed latch that can be moved to a closed position by a directional closing movement of a mechanism and opened in a directional opening movement that is opposite in direction to the directional closing movement, the mechanism being accessible through a longitudinal hole that is unaligned with the mechanism, the direction of the opening movement of the mechanism being substantially perpendicular to the longitudinal hole, the method comprising the steps of:
a) forming a substantially elongated resilient member having a first end portion that is connected by means of a first curved portion to a second portion which is connected by means of a third portion to a second end portion, the first curved portion having greater curvature along its length than either of the first end portion or the second portion have along their lengths, the combined length of the first end portion, the first curved portion and the second portion being greater than the distance through the longitudinal hole to the mechanism, the second portion having a curvature that is sufficiently small so that the second portion defines a longitudinal axis, the second end portion having a length and being angularly disposed relative to the second portion sufficiently so that the resilient member can be turned relative to the longitudinal axis without undue effort;
b) passing the first end portion, the first curved portion and at least part of the second portion through the longitudinal hole so that the resilient member is adjacent the mechanism;
c) turning the resilient member through an angle relative to its longitudinal axis until the first end portion is oriented to engage the mechanism;
d) partially withdrawing the resilient member from the longitudinal hole until the first end portion engages the mechanism; and
e) causing the mechanism to be moved sufficiently in the direction of the opening movement so that the latch is opened.

17. The method of claim 16, further comprising the step of:
f) causing the resilient member to impart sufficient energy to the mechanism as the first end portion of the resilient member is withdrawn past the mechanism so that the mechanism is caused to move from the closed position to a stable open position.

18. The method of claim 16, wherein step a) further comprises forming the resilient member to be planar.

19. A method for opening a closed latch that can be closed by a directional closing movement of a mechanism to deny access to a first space from a second space and opened in a directional opening movement that is opposite in direction to the directional closing movement, the mechanism being accessible from the second space through a longitudinal hole that is unaligned with the mechanism, the direction of the opening movement of the mechanism being substantially perpendicular to the longitudinal hole, the method comprising the steps of:
a) forming the longitudinal hole;
b) forming a substantially elongated resilient member having a first end portion that is connected by means of a first convexly curved portion to a second portion which is connected by means of a third convexly curved portion to a second end portion, the first convexly curved portion having greater curvature than the second portion, the combined length of the first end portion and the first and second portions being greater than the distance from the second space through the longitudinal hole to the mechanism, the second portion having a curvature that is sufficiently small so that the second portion defines a longitudinal axis, the second end portion having a length and being angularly disposed relative to the second portion sufficiently so that the resilient member can be turned relative to the longitudinal axis without undue effort;
c) passing the resilient member from the second space through the longitudinal hole so that the first end portion, the first convexly curved portion and at least part of the second portion are passed through the longitudinal hole so that the resilient member is adjacent the mechanism;
d) turning the resilient member through an obtuse angle relative to its longitudinal axis until the first end portion is oriented to engage the mechanism;
e) partially withdrawing the resilient member from the first space through the longitudinal hole until the first end portion engages the mechanism; and
f) causing the mechanism to be moved sufficiently in the direction of the opening movement so that the latch is opened.

20. The method of claim 19, further including the step of:
g) causing the resilient member to impart sufficient energy to the mechanism as the first end portion of the resilient member is withdrawn past the mechanism so that the mechanism is caused to move from the closed position to a stable open position.

21. A method for opening a closed latch that can be closed by a downward movement of a mechanism, the latch being attached to a door frame having a doorstop and denying access to a first space through the door from a second space when the latch is closed, the latch further being opened in a directional opening movement that is opposite in direction to the directional closing movement, the doorstop having a substantially horizontal hole therethrough below the mechanism, the method comprising the steps of:
a) forming a substantially elongated resilient member having a first convexly curved end portion that is longer than the horizontal hole through the doorstop, the first convexly curved end portion being connected by means of a first convexly curved connection portion to a second convexly curved connection portion that is connected by means of a third convexly curved connection portion to a second end portion, the first convexly curved connection portion having a greater curvature than the second convexly curved portion, the combined length of the first end portion and the first and second curved connection portions being greater than the width of the door frame, the second curved portion having a curvature that is sufficiently small so that the second curved portion defines a longitudinal axis, the second end portion having a length and being angularly disposed relative to the second curved connection portion sufficiently so that the resilient member can be turned relative to the longitudinal axis without undue effort;
b) passing the first curved end portion, the first curved connection portion and at least part of the second curved connection portion through the horizontal hole so that the resilient member is below the mechanism;
c) turning the resilient member through an angle of substantially 180 degrees relative to its longitudinal axis until the first end portion bears against the mechanism; and
d) partially withdrawing the resilient member from the horizontal hole until the first curved end portion causes the mechanism to be lifted upwardly sufficiently so that it is opened.

22. The method of claim 21, further comprising the step of:
e) imparting sufficient energy from the resilient member to the mechanism as the first end portion of the resilient member is withdrawn past the mechanism so that the mechanism is caused to move from the closed position to a stable open position.

23. The method of claim 21, wherein step a) includes forming the resilient member to follow a planar convex curve.

24. A method for opening a closed latch that can be closed by a downward movement of a mechanism, the latch being attached to a door frame having a doorstop and denying access to a first space through a door from a second space when the latch is closed, the door being capable of closing against the doorstop and the latch having a strikeplate that receives a bolt from the door, the latch further being opened in a directional opening movement that is opposite in direction to the directional closing movement, the doorstop having a substantially horizontal hole therethrough below the mechanism, the method comprising the steps of:
a) forming a substantially elongated resilient member having a first end portion that is longer than the horizontal hole through the doorstop, the first end portion being connected by means of a first convexly curved connection portion to a second convexly curved connection portion that is connected by means of a third convexly curved connection portion to a second end portion, the first convexly curved connection portion having a greater curvature than the second convexly curved connection portion, the combined length of the first end portion and the first and second convexly curved connection portions being greater than the width of the door frame, the third convexly curved connection portion having greater curvature than the second convexly curved connection portion and the second end portion being at a substantially right angle to the second convexly curved connection portion;
b) passing the resilient member through the horizontal hole from the second space so that the first end portion, the first convexly curved connection portion and at least part of the second convexly curved connection portion can be passed through the horizontal hole from the second space toward the first space so that the resilient member is above the bolt and below the mechanism;
c) turning the resilient member through an angle of substantially 180 degrees relative to its longitudinal axis until the first end portion bears against the mechanism; and
d) partially withdrawing the resilient member from the horizontal hole toward the second space until the first convexly curved end portion causes the mechanism to be lifted upwardly sufficiently so that it is opened.

25. The method of claim 24, further comprising the step of:
e) causing the resilient member to impart sufficient energy to the mechanism as the first end portion of the resilient member is withdrawn past the mechanism so that the mechanism is caused to move from the closed position to a stable open position.

26. The method of claim 24, wherein step a) includes forming the resilient member as a planar convex curve.
